(19) United States
(12) Patent Application Publication
(10) Pub. No.: US 2018/0017023 A1
(43) Pub. Date: Jan. 18, 2018

(54) FUEL SYSTEM HAVING VENT POINT VALVE

(71) Applicant: Eaton Corporation, Cleveland, OH (US)

(72) Inventor: Vaughn K. Mills, Chelsea, MI (US)

(73) Assignee: Eaton Corporation, Cleveland, OH (US)

(21) Appl. No.: 15/718,543

(22) Filed: Sep. 28, 2017

Related U.S. Application Data
(63) Continuation of application No. PCT/US2016/024668, filed on Mar. 29, 2016.
(60) Provisional application No. 62/139,776, filed on Mar. 29, 2015.

(51) Int. Cl. F02M 25/08; B60K 15/035; B60K 15/03

(52) U.S. Cl. CPC F02M 25/0872; B60K 15/03519; F02M 25/0854; B60K 15/03504; B60K 2015/03514; B60K 2015/03289

(57) ABSTRACT

A fuel tank system includes a fuel tank, a liquid trap and a tank venting assembly. The fuel tank defines a first vapor space and a second vapor space. The tank venting assembly includes a vent valve, a first vent line, a second vent line and a third vent line. The vent valve can have a movable member that is configured to move between a first open position wherein a front vent point is open and a second closed position wherein the front vent point is closed. The first vent line can be fluidly connected between the liquid trap and the vent valve. The second vent line can be fluidly connected between the vent valve and an auxiliary vent point. The third vent line can connect to an upper vent point. In a closed position, the auxiliary vent point and the upper vent point remain open and vented.

### CROSS-REFERENCE TO RELATED APPLICATIONS

This application is a continuation of International Application No. PCT/US2016/024668 filed Mar. 29, 2016, which claims priority to U.S. Provisional Application No. 62/139,776 filed on Mar. 29, 2015, which is incorporated by reference in its entirety as if set forth herein.

### FIELD

The present disclosure relates generally to fuel tanks on passenger vehicles and more particularly to a fuel tank that allows point venting during extreme tip angles.

### BACKGROUND

Proper venting and handling of fuel and fuel vapor is required for fuel tanks. More particularly, fuel tanks must be properly vented for passenger motor vehicles. Furthermore, fuel tanks must properly account for containment of liquid fuel.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A fuel tank system constructed in accordance to one example of the present disclosure includes a fuel tank, a liquid trap and a tank venting assembly. The fuel tank can be configured as a reservoir for holding fuel to be supplied to an internal combustion engine. The fuel tank can define a first vapor space and a second vapor space at an area distinct from the first vapor space. The tank venting assembly can include a vent valve, a first vent line, a second vent line and a third vent line. The vent valve can have a movable member that is configured to move between a first open position wherein a front vent point is open and a second closed position wherein the front vent point is closed. The first vent line can be fluidly connected between the liquid trap and the vent valve. The second vent line can be fluidly connected between the vent valve and an auxiliary vent point at the first vapor space. The third vent line can be fluidly connected between the liquid trap and an upper vent point at the second vapor space. The vent valve is configured to move to the closed position upon a fuel level reaching a predetermined level. In the closed position, the auxiliary vent point and the upper vent point remain open and vented to the liquid trap.

According to additional features, the fuel tank further defines a third vapor space at the vent valve. The third vapor space can occupy an area distinct from the first and second vapor space. The liquid trap can further comprise a drain mechanism. The movable member can sealingly engage a valve seat in the second closed position. The movable member can comprise a cup that is configured to float relative to liquid fuel. The vent valve can permit vapor to pass between the first vent line and the second vent line in the first open position. The auxiliary vent point and the upper vent point can both concurrently open during a refueling event. The auxiliary vent point and the upper vent point are both concurrently open at a fuel level full condition. The fuel tank system can further comprise a purge canister adapted to collect fuel vapor emitted by the fuel tank and subsequently release the fuel vapor to the internal combustion engine.

A fuel tank system constructed in accordance to another example of the present disclosure includes a fuel tank, a liquid trap and a tank venting assembly. The fuel tank can be configured as a reservoir for holding fuel to be supplied to an internal combustion engine. The fuel tank can have a first vapor space, a second vapor space and a third vapor space. The first, second and third vapor spaces can be located at distinct areas within the fuel tank. The liquid trap can be disposed in the fuel tank. The tank venting assembly can comprise a vent valve, a first vent line, a second vent line and a third vent line. The vent valve can have a movable member that is configured to move between a first open position wherein a front vent point located at the third vapor space is open and a second closed position wherein the front vent point is closed. The first vent line can be fluidly connected between the liquid trap and the vent valve. The second vent line can be fluidly connected between the vent valve and an auxiliary vent point at the first vapor space. The third vent line can be fluidly connected between the liquid trap and an upper vent point at the second vapor space. The vent valve can be configured to move to the closed position upon a fuel level reaching a predetermined level. In the closed position, the auxiliary vent point and the upper vent point remain open and vented.

According to other features, the third vapor space occupies an area near a front portion of the fuel tank at an elevation between the liquid trap and the auxiliary vent point. The liquid trap can further comprise a drain mechanism. The movable member can sealingly engage a valve seat in the second closed position. The movable member can comprise a cup that is configured to float relative to liquid fuel. The vent valve can permit vapor to pass between the first vent line and the second vent line in the first open position. The auxiliary vent point and the upper vent point can both concurrently open during a refueling event. The auxiliary vent point and the upper vent point are both concurrently open at a fuel level full condition.

According to additional features, the fuel tank system can include a purge canister adapted to collect fuel vapor emitted by the fuel tank and subsequently release the fuel vapor to the internal combustion engine. The fuel tank system can further include a purge canister configured to collect fuel vapor emitted by the fuel tank and subsequently release the fuel vapor to the internal combustion engine during a purge event. The fuel tank system can additionally include a first vapor line fluidly connected between the liquid trap and the purge canister.

### BRIEF DESCRIPTION OF THE DRAWINGS

The present disclosure will become more fully understood from the detailed description and the accompanying drawings, wherein:

FIG. 1 is a schematic illustration of a fuel tank constructed in accordance to one example of prior art;

FIG. 2 is a schematic illustration of the fuel tank of FIG. 1 showing a 30% nose down example;

FIG. 3 is a schematic illustration of the fuel tank of FIG. 1 showing a 30% nose up configuration;

FIG. 4 is a schematic illustration of a fuel tank having an in-line valve and constructed in accordance to one example of the present disclosure;

FIG. 5A is a detail view of the in-line valve of FIG. 4 and shown in an open position; and

FIG. 5B is a detail view of the in-line valve of FIG. 4 and shown in a closed position.

### DETAILED DESCRIPTION

With reference now to FIG. 1, a fuel tank constructed in accordance to one example of prior art is shown and generally identified at reference 10. Typically a fuel tank can have at least two vent points to allow for venting at various grades. In this regard, when the fuel tank is tipped resulting from the vehicle on various grades, the fuel tank must adequately vent. The fuel tank 10 is configured in a generally L-shaped layout including a generally front section 12 and a generally rear section 14. The front section 12 can be shallower than the rear section 14. The front section 12 can include a first vent port 20. The rear section 14 can include a second vent port 22. The fuel tank 10 is shown in a 100% fill example where the first vent port 20 is submerged at level ground. If full refueling flow is needed by both the first and the second vent ports 20, 22, then the first vent port 20 must proceed to the vapor space at 100%. However, in the configuration shown in FIG. 1, the first vent port 20 is temporarily blocked.

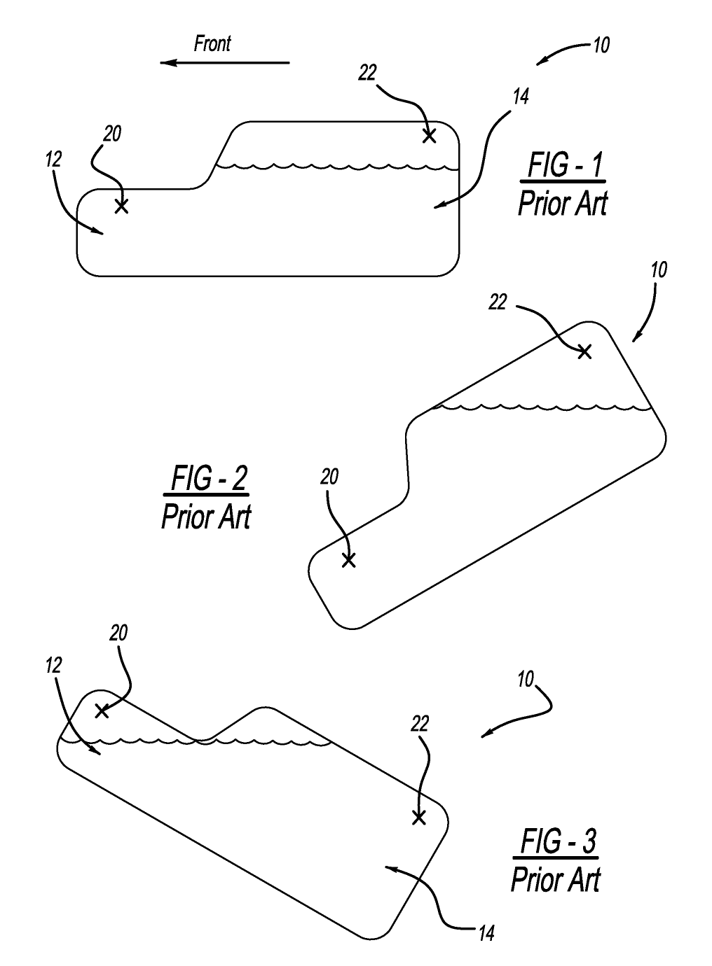

In the example shown in FIG. 2, the fuel tank 10 is shown in a 30% nose down configuration where the first vent port 20 is submerged and the second vent port 22 is not submerged. In this example, the fuel tank 10 will only be able to vent from the second vent port 22 and not the first vent port 20. In the example shown in FIG. 3, the fuel tank 10 is shown in a 30% nose up configuration where the second vent port 22 is submerged and the first vent port 20 is not submerged. In this example, the fuel tank 10 will only be able to vent from the first vent port 20 and not the second vent port 22. It will be appreciated that while the schematic depiction shows a “front” and a “rear” vent port 20, 22, the vents may be located elsewhere. For example the vents may be additionally or alternatively located on one or both sides of the fuel tank 10. Moreover, while the locations of the front and rear vents 20 and 22 are shown at a particular area of the fuel tank 10, they may be moved to different locations in the “front” of the fuel tank 12 and/or the “rear” of the fuel tank 14. Regardless, it is desirable to have at least one vent port 20, 22 open during a refueling event while the vehicle is at any reasonable grade level. Moreover, when the vehicle is in park, or driving an amount of venting is required in the fuel tank 14. In general, a greater amount of venting is desired during a refueling event as compared to driving or while in park.

The following disclosure can further be applicable to electronic venting systems as well such as disclosed in commonly owned PCT/US2015/051950, filed Sep. 24, 2015, the disclosure of which is expressly incorporated herein by reference.

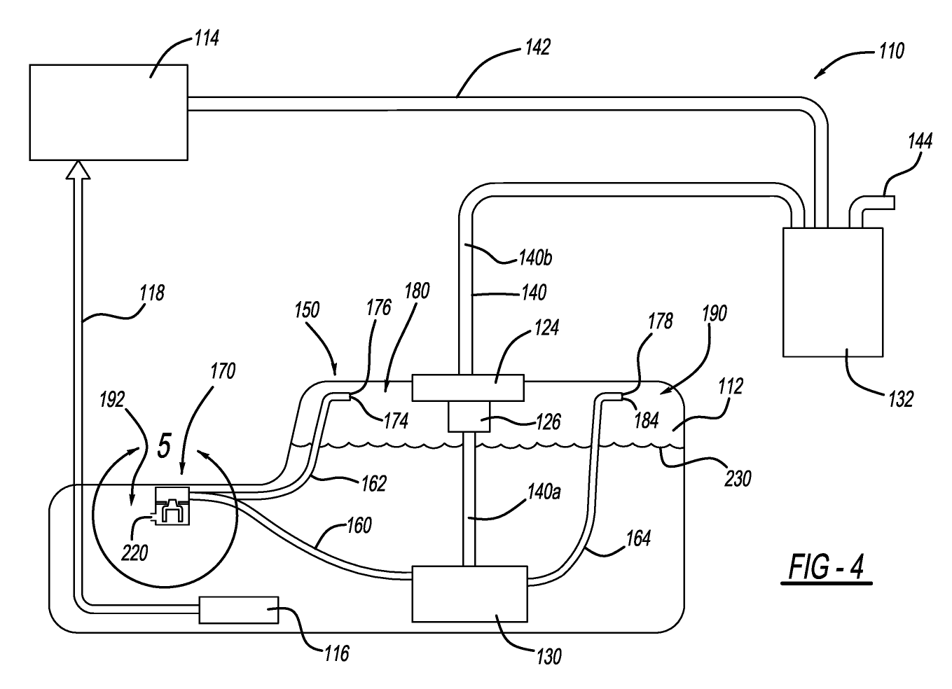

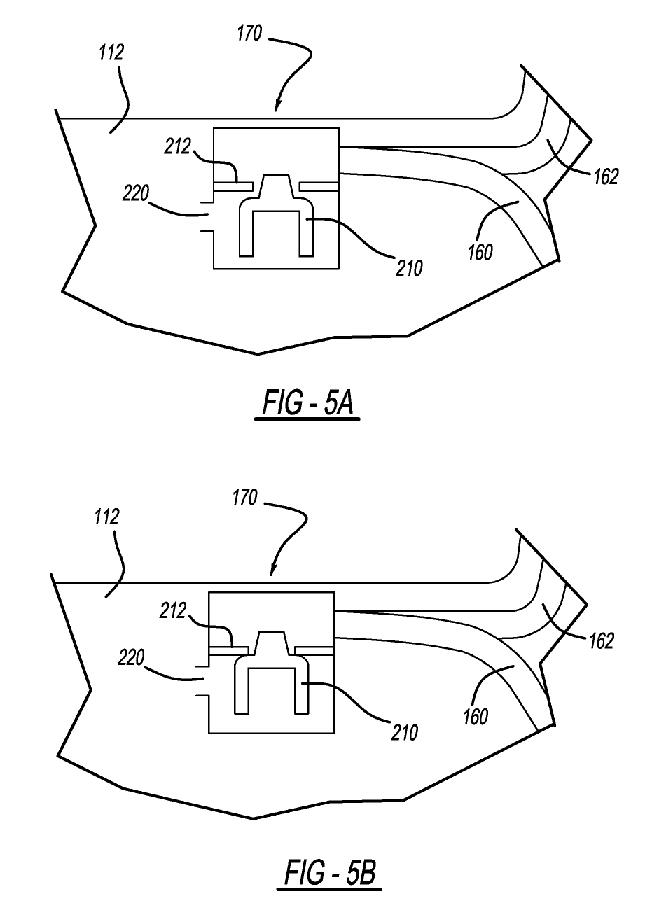

With reference to FIGS. 4, 5A and 5B, a fuel tank system 110 constructed in accordance to one example of the present disclosure is shown. The fuel tank system 110 can include a fuel tank 112 configured as a reservoir for holding fuel to be supplied to an internal combustion engine 114 via a fuel delivery system, which includes a fuel pump 116. The fuel pump 116 can be configured to deliver fuel through a fuel supply line 118 to the vehicle engine 114. A fuel vapor recovery system 120 can be configured to recycle fuel vapor emitted in the fuel tank system 110. The fuel vapor recovery system 120 can generally include a manifold assembly 124, a safety valve 126, a liquid trap 130 and a carbon or purge canister 132.

A first vapor line 140 can be fluidly connected between the liquid trap 130 and the purge canister 132. The first vapor line 140 can collectively be formed by vapor line 140a connected between the liquid trap 130 and safety valve 126 and vapor line 140b connected between the manifold assembly 124 and the purge canister 132. A second vapor line 142 can be connected between the purge canister 132 and the engine 114. In the example implementation, the manifold assembly 124 can be configured to control a flow of fuel vapor between the fuel tank 112 and the purge canister 132. The purge canister 132 can be adapted to collect fuel vapor emitted by the fuel tank 112 and can subsequently release the fuel vapor to the engine 114 through the second vapor line 142. A canister vent line 144 can be connected from the purge canister 132 to atmosphere. During a purge event, fresh air is drawn through the purge canister 123. In one example the safety valve 126 can inhibit liquid fuel from entering the vapor line 140b.

The fuel tank system 110 according to the present disclosure can further include a tank venting assembly 150. As will become appreciated the tank venting assembly 150 can provide sufficient venting during refueling when the vehicle is at various grades. The tank venting assembly 150 includes a first vent line 160, a second vent line 162 and a third vent line 164. A vent valve 170 can fluidly couple the first vent line 160 and the second vent line 162. The first vent line 160 can be fluidly connected between the liquid trap 130 and the vent valve 170. The second vent line 162 can have a first end that is fluidly connected to the vent valve 170 and a second end 174 that extends to an auxiliary vent point 176 at a first vapor space 180. The third vent line 164 can have a first end that is fluidly connected to the liquid trap 130 and a second end 184 that extends to an upper vent point 178 at a second vapor space 190. The vent valve 170 can generally be located at a third vapor space 192. In the example shown, the first and second vapor spaces 180 and 190 can be located generally near an upper area of the fuel tank 112. The third vapor space 192 can be located generally near a front area of the fuel tank 112. The third vapor space 192 occupies an area near a front portion of the fuel tank 112 at an elevation between the liquid trap 130 and the auxiliary vent port 176 when the vehicle is on level ground. In the example shown the front area of the fuel tank can generally be shallower as compared to the remainder of the fuel tank 112. It will be appreciated by those skilled in the art that the geometry of the fuel tank 112 is exemplary and the present teachings can be applicable to fuel tanks having other configurations.

The vent valve 170 can include a movable member or cup 210 that is configured to move between a first open position (FIG. 5A) and a second closed position (FIG. 5B). In the open position, the cup 210 is offset from a valve seat 212 such that the first vent line 160 is open to a front vent point 220. In general, the cup 210 floats relative to liquid fuel in the fuel tank 112. The cup 210 has a generally conical shape. It will be appreciated however that the cup 210 can have other shapes within the scope of the present disclosure. It will be further appreciated that other valve configurations may be used in place of the vent valve 170 for providing a mechanism that selectively vents to a desired area of the fuel tank 112.

When the fuel level is below the cup 210, the cup 210 will occupy the position in FIG. 5A such that the first vent line 160 is open to the front vent point 220. In one example, the vent valve 170 can also permit vapor to pass between the first vent line 160 and the second vent line 162. According to additional features, the liquid trap 130 can include an on/off mechanism for the auxiliary vent point 176, the upper vent point 178 and the front vent point 220. The liquid trap 130 can further include a drain mechanism. In one example the liquid trap 130 can include a venturi jet that drains liquid by way of a vacuum out of the liquid trap 130 when the fuel pump 116 is on.

When the fuel level rises above the cup 210, the cup 210 will sealingly engage the valve seat 212. In this position, the front vent point 220 is closed. However, the second vent line 162 remains open at the auxiliary vent point 176. In this regard, when fuel level is above the vent valve 170 such as at a fuel level full (100% full) line 230, the vent valve 170 closes permitting venting at the auxiliary vent point 176 (and at the upper vent point 178). Explained further, when the vent valve 170 is closed, the upper vent point 178 and the auxiliary vent point 176 remain vented making available two distinct vent points during a refueling event.

The foregoing description of the examples has been provided for purposes of illustration and description. It is not intended to be exhaustive or to limit the disclosure. Individual elements or features of a particular example are generally not limited to that particular example, but, where applicable, are interchangeable and can be used in a selected example, even if not specifically shown or described. The same may also be varied in many ways. Such variations are not to be regarded as a departure from the disclosure, and all such modifications are intended to be included within the scope of the disclosure.

What is claimed is:

1. A fuel tank system comprising:
a fuel tank configured as a reservoir for holding fuel to be supplied to an internal combustion engine, the fuel tank defining a first vapor space and a second vapor space at an area distinct from the first vapor space;
a liquid trap;
a tank venting assembly comprising:
a vent valve having a movable member that is configured to move between a first open position wherein a front vent point is open and a second closed position wherein the front vent point is closed;
a first vent line fluidly connected between the liquid trap and the vent valve;
a second vent line fluidly connected between the vent valve and an auxiliary vent point at the first vapor space; and
a third vent line fluidly connected between the liquid trap and an upper vent point at the second vapor space; and
wherein the vent valve is configured to move to the closed position upon a fuel level reaching a predetermined level, wherein in the closed position, the auxiliary vent point and the upper vent point remain open and vented to the liquid trap.

2. The fuel tank system of claim 1 wherein the fuel tank further defines a third vapor space at the vent valve, the third vapor space occupying an area distinct from the first and second vapor space.

3. The fuel tank system of claim 1 wherein the liquid trap further comprises a drain mechanism.

4. The fuel tank system of claim 1 wherein the movable member sealingly engages a valve seat in the second closed position.

5. The fuel tank system of claim 4 wherein the movable member comprises a cup configured to float relative to liquid fuel.

6. The fuel tank system of claim 1 wherein the vent valve permits vapor to pass between the first vent line and the second vent line in the first open position.

7. The fuel tank system of claim 1 wherein the auxiliary vent point and the upper vent point are both concurrently open during a refueling event.

8. The fuel tank system of claim 7 wherein the auxiliary vent point and the upper vent point are both concurrently open at a fuel level full condition.

9. The fuel tank system of claim 1, further comprising a purge canister adapted to collect fuel vapor emitted by the fuel tank and subsequently release the fuel vapor to the internal combustion engine.

10. A fuel tank system comprising:
a fuel tank configured as a reservoir for holding fuel to be supplied to an internal combustion engine, the fuel tank defining a first vapor space, a second vapor space, and a third vapor space, the first, second and third vapor spaces being located at distinct areas within the fuel tank;
a liquid trap disposed in the fuel tank;
a tank venting assembly comprising:
a vent valve having a movable member that is configured to move between a first open position wherein a front vent point located at the third vapor space is open and a second closed position wherein the front vent point is closed;
a first vent line fluidly connected between the liquid trap and the vent valve;
a second vent line fluidly connected between the vent valve and an auxiliary vent point at the first vapor space; and
a third vent line fluidly connected between the liquid trap and an upper vent point at the second vapor space; and
wherein the vent valve is configured to move to the closed position upon a fuel level reaching a predetermined level, wherein in the closed position, the auxiliary vent point and the upper vent point remain open and vented.

11. The fuel tank system of claim 10 wherein the third vapor space occupies an area near a front portion of the fuel tank at an elevation between the liquid trap and the auxiliary vent port.

12. The fuel tank system of claim 10 wherein the liquid trap further comprises a drain mechanism.

13. The fuel tank system of claim 10 wherein the movable member sealingly engages a valve seat in the second closed position.

14. The fuel tank system of claim 13 wherein the movable member comprises a cup configured to float relative to liquid fuel.

15. The fuel tank system of claim 10 wherein the vent valve permits vapor to pass between the first vent line and the second vent line in the first open position.

16. The fuel tank system of claim 10 wherein the auxiliary vent point and the upper vent point are both concurrently open during a refueling event.

17. The fuel tank system of claim 16 wherein the auxiliary vent point and the upper vent point are both concurrently open at a fuel level full condition.

18. The fuel tank system of claim 10, further comprising a purge canister adapted to collect fuel vapor emitted by the fuel tank and subsequently release the fuel vapor to the internal combustion engine.

19. The fuel tank system of claim 10 wherein the fuel tank system further includes a purge canister configured to collect fuel vapor emitted by the fuel tank and subsequently release the fuel vapor to the internal combustion engine during a purge event.

20. The fuel tank system of claim 19, further comprising a first vapor line fluidly connected between the liquid trap and the purge canister.
